(19) United States
(12) Patent Application Publication
(10) Pub. No.: US 2013/0042690 A1
(43) Pub. Date: Feb. 21, 2013

(54) ULTRASONIC SENSOR

(71) Applicants: Boum Seock Kim, Gyunggi-do (KR); Eun Tae Park, Gyunggi-do (KR)

(72) Inventors: Boum Seock Kim, Gyunggi-do (KR); Eun Tae Park, Gyunggi-do (KR)

(73) Assignee: SAMSUNG ELECTRO-MECHANICS CO., LTD., Gyunggi-do (KR)

(21) Appl. No.: 13/326,127

(22) Filed: Dec. 14, 2011

(30) Foreign Application Priority Data
Aug. 19, 2011 (KR) 1020110082972

(51) Int. Cl. G01N 29/22

(52) U.S. Cl. 73/632

(57) ABSTRACT

Disclosed herein is an ultrasonic sensor including: a case; a piezoelectric element mounted on an inner side bottom surface of the case; a first sound absorbing material having a through-hole formed at an area thereof corresponding to a mounting area of the piezoelectric element and including the piezoelectric element disposed at a portion thereof based on a thickness of the through-hole; and a second sound absorbing material formed on the first sound absorbing material so as to cover the entire surface of the first sound absorbing material including the through-hole, wherein the through-hole formed has a thickness thicker than that of the piezoelectric element.

### CROSS REFERENCE TO RELATED APPLICATION

This application claims the benefit of Korean Patent Application No. 10-2011-0082972, filed on Aug. 19, 2011, entitled “Ultrasonic Sensor”, which is hereby incorporated by reference in its entirety into this application.

### BACKGROUND OF THE INVENTION

1. Technical Field

The present invention relates to an ultrasonic sensor.

2. Description of the Related Art

An ultrasonic sensor is a sensor using the principle in which as a voltage is applied to a piezoelectric material, the piezoelectric material is periodically deformed to thereby generate an ultrasonic wave and an ultrasonic wave returned by reflection of the generated ultrasonic wave on an obstacle is re-measured to thereby calculate an actual distance.

The above-mentioned ultrasonic sensor has been used in various fields including a rear stabilization device for a vehicle that may sense an obstacle at the time of backing of a vehicle to thereby prevent an accident.

The above-mentioned ultrasonic sensor is mounted with a piezoelectric element generating an ultrasonic wave. Vibration of this piezoelectric element is diffused outside a case, such that the above-mentioned ultrasonic sensor serves as a sensor.

In this situation, internal vibration corresponding to noise other than vibration required for sensing an object is generated, which causes accuracy of an object detection result to be lowered.

Therefore, a technology for decaying the vibration corresponding to noise other than the vibration required for sensing an object in the ultrasonic sensor has been demanded.

Meanwhile, as a scheme for decaying the vibration corresponding to noise in the ultrasonic sensor, a technology of disposing a sound absorbing material on a piezoelectric element in a case has been used.

However, the above-mentioned structure hinders vibration of the piezoelectric element, thereby causing accuracy of object recognition to be lowered.

### SUMMARY OF THE INVENTION

The present invention has been made in an effort to provide an ultrasonic sensor allowing vibration of a piezoelectric element for recognizing an object to be freely made.

Further, the present invention has been made in an effort to provide an ultrasonic sensor for decaying noise vibration of a piezoelectric element

According to a preferred embodiment of the present invention, there is provided an ultrasonic sensor including: a case; a piezoelectric element mounted on an inner side bottom surface of the case; a first sound absorbing material having a through-hole formed at an area thereof corresponding to a mounting area of the piezoelectric element and including the piezoelectric element disposed at a portion thereof based on a thickness of the through-hole; and a second sound absorbing material formed on the first sound absorbing material so as to cover the entire surface of the first sound absorbing material including the through-hole, wherein the through-hole formed has a thickness thicker than that of the piezoelectric element.

The through-hole may have a size corresponding to that of the piezoelectric element.

The piezoelectric element may be disposed in the through-hole so that a spaced space is formed between the piezoelectric element and the second sound absorbing material.

The first and second sound absorbing materials may be the same material or different materials.

Each of the first and second sound absorbing materials may be non-woven or cork.

The first sound absorbing material may be formed in a form in which it is filled in a space between a side of the piezoelectric element and a wall surface of the case.

The case may be made of aluminum.

When the piezoelectric element is mounted in the case, the piezoelectric element may be adhered to the case by an adhesive.

The adhesive may be epoxy.

When a bottom surface of the case has an oval shape, an area of the first sound absorbing material except for the through-hole in which the piezoelectric element is to be mounted may be formed so as to correspond to the oval shape, and the second sound absorbing material may be formed so as to correspond to the oval shape.

### BRIEF DESCRIPTION OF THE DRAWINGS

FIG. 1 is a view showing a configuration of an ultrasonic sensor according to a preferred embodiment of the present invention;

FIG. 2 is a view showing a configuration of a first sound absorbing material according to the preferred embodiment of the present invention in detail;

FIG. 3 is a view showing an example in which the first sound absorbing material is formed in a case according to the preferred embodiment of the present invention; and

FIG. 4 is a view showing another example in which the first sound absorbing material is formed in a case according to the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

Ultrasonic Sensor

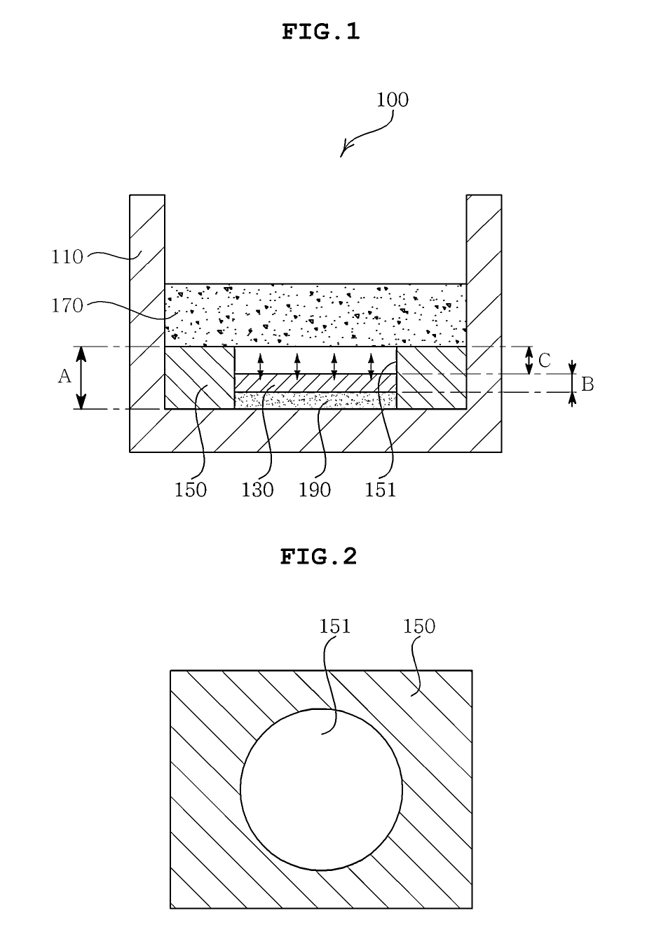

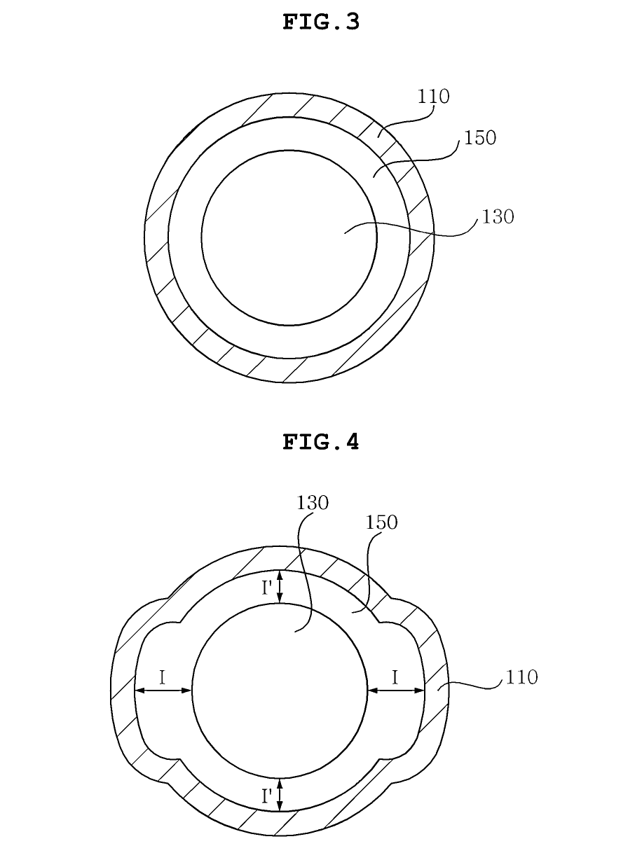

FIG. 1 is a view showing a configuration of an ultrasonic sensor according to a preferred embodiment of the present invention; FIG. 2 is a view showing a configuration of a first sound absorbing material according to the preferred embodiment of the present invention in detail; FIG. 3 is a view showing an example in which the first sound absorbing material is formed in a case according to the preferred embodiment of the present invention; and FIG. 4 is a view showing another example in which the first sound absorbing material is formed in a case according to the preferred embodiment of the present invention.

As shown in FIG. 1, an ultrasonic sensor 100 according to a preferred embodiment of the present invention may include a case 110, a piezoelectric element 130 mounted on an inner side bottom surface of the case 110, a first sound absorbing material 150 having a through-hole 151 formed at an area thereof corresponding to a mounting area of the piezoelectric element 130 and including the piezoelectric element 130 disposed at a portion thereof based on a thickness of the through-hole 151, and a second sound absorbing material 170 formed on the first sound absorbing material 150 so as to cover the entire surface of the first sound absorbing material 150 including the through-hole 151.

As shown in FIG. 1, the through-hole 151 formed in the first sound absorbing material 150 may have a thickness A thicker than a thickness (B) of the piezoelectric element 130.

That is, the piezoelectric element 130 is disposed in the through-hole 151 so that a spaced space C is formed between the piezoelectric element 130 and the second sound absorbing material 170.

Here, since the piezoelectric element 130 and the second sound absorbing material 170 include the spaced space C formed therebetween, there is no material reducing vibration force of the piezoelectric element 130. Therefore, the vibration for detecting an object is smoothly generated, thereby making it possible to obtain a more accurate object recognition result

In addition, the through-hole 151 may have a size corresponding to that of the piezoelectric element 130.

As shown in FIG. 2, the first sound absorbing material 150 includes the through-hole 151 formed so as to correspond to a size in which a shape (for example, a circular shape) of the piezoelectric element 130 is reflected.

Although FIG. 2 shows a case in which an outer surface of the first sound absorbing material 150 has rectangular shape for convenience of explanation, the outer surface of the first sound absorbing material 150 may be changed according to a shape of the case 110.

Since the piezoelectric element 130 is disposed in the through-hole 151 formed so as to correspond to (formed so as to be the same as) its size on a plane, while having a spaced space on an upper surface thereof, when vibration occurs, vertical vibration force required for recognizing an object may be increased and horizontal vibration force acting as noise in recognizing the object may be decreased.

Here, the term ‘same’ means substantially the same size in consideration of a manufacturing error, a measuring error, or the like, in accurately the same dimension in a mathematical meaning.

Meanwhile, as shown in FIGS. 3 and 4, the first sound absorbing material 150 may have a circular shape or an oval shape according to a shape of the case 110 and include the through-hole 151 formed so as to correspond to a mounting area of the piezoelectric element 130.

The first sound absorbing material 150 shown in FIGS. 3 and 4 is formed in a form in which it is filled in a space between a side of the piezoelectric element 130 and a wall surface of the case.

In addition, since a spaced interval between the piezoelectric element 130 and the wall surface of the case 110 is wider in a structure of the first sound absorbing material 150 having an oval shape in which a horizontal diameter I is larger than a vertical diameter I′ on a plane shown in FIG. 4 than in a structure of FIG. 3, horizontal vibration generated from the piezoelectric element 130 may be decayed.

That is, as shown in FIG. 4, when a bottom surface of the case 110 has an oval shape, an area of the first sound absorbing material 150 except for the through-hole 151 in which the piezoelectric element 130 is to be mounted is formed so as to correspond to the oval shape, and the second sound absorbing material 170 is formed so as to correspond to the oval shape.

Meanwhile, it is possible to reduce vibration generated toward the side of the piezoelectric element by about 80% (for example, in the case of a material such as non-woven having absorption coefficients of 0.8 or more) in structure in which the sound absorbing material is formed in a form in which it is completely filled in the space between the piezoelectric element 130 and the case 110 according to the preferred embodiment of the present invention, as compared to a general structure in which the sound absorbing material is disposed on the piezoelectric element, such that a spaced space is formed between the piezoelectric element and the case.

On the other hand, in the case of the ultrasonic sensor having the general structure of the sound absorbing material described above, residual vibration generated from the piezoelectric element and corresponding to the noise may be propagated to the wall surface of the case.

The ultrasonic sensor according to the preferred embodiment of the present invention described above may reduce a decay time by about 20% to 30%. Here, the decay time means a time required to decay vibration generated by transmitting an ultrasonic wave.

For example, a decay time of a general ultrasonic sensor is about 2 ms, and there is an error of about 10 to 20 cm when a speed of a vehicle at the time of parking is 20 to 40 km/hr.

However, in the case of the ultrasonic sensor having the structure of the sound absorbing material according to the preferred embodiment of the present invention, a decay time is reduced by about 20% to 30%, thereby making it possible to more securely sense a distance of 5 cm or more as compared to the case according to the prior art.

In addition, the first and second sound absorbing materials 150 and 170 may be the same material or different materials.

Further, each of the first and second sound absorbing materials 150 and 170 may be non-woven or cork.

Here, the cork may more efficiently prevent penetration of a molding liquid filled in an upper portion of the second sound absorbing material 170, such that a sound absorbing effect is improved, thereby making it possible to reduce a vibration decay time through vibration decay. In addition, the cork is cheaper than other materials (for example, a silicon, or the like), thereby making it possible to reduce a process cost.

That is, when the cork is used as the second sound absorbing material 170, the cork may prevent penetration of the molding material and serve as a secondary sound absorbing material.

In addition, the case 110 may be made of aluminum but is not limited thereto.

In addition, as shown in FIG. 1, when the piezoelectric element 130 is mounted in the case 110, the piezoelectric element 130 may be adhered to the case 110 by an adhesive 190.

Here, the adhesive 190 may be epoxy but is not limited thereto.

With the ultrasonic sensor according to the preferred embodiment of the present invention, the sound absorbing material having the through-hole corresponding to the mounting area of the piezoelectric element is used to improve a degree of freedom in vibration of the piezoelectric element, thereby making it possible to improve object recognition accuracy.

In addition, according to the preferred embodiment of the present invention, a plurality of sound absorbing materials are used, thereby making it possible to decay noise vibration of the piezoelectric element.

Although the embodiment of the present invention has been disclosed for illustrative purposes, it will be appreciated that an ultrasonic sensor according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An ultrasonic sensor comprising:
a case;
a piezoelectric element mounted on an inner side bottom surface of the case;
a first sound absorbing material having a through-hole formed at an area thereof corresponding to a mounting area of the piezoelectric element and including the piezoelectric element disposed at a portion thereof based on a thickness of the through-hole; and
a second sound absorbing material formed on the first sound absorbing material so as to cover the entire surface of the first sound absorbing material including the through-hole,
wherein the through-hole formed has a thickness thicker than that of the piezoelectric element.

2. The ultrasonic sensor as set forth in claim 1, wherein the through-hole has a size corresponding to that of the piezoelectric element

3. The ultrasonic sensor as set forth in claim 1, wherein the piezoelectric element is disposed in the through-hole so that a spaced space is formed between the piezoelectric element and the second sound absorbing material.

4. The ultrasonic sensor as set forth in claim 1, wherein the first and second sound absorbing materials are the same material or different materials.

5. The ultrasonic sensor as set forth in claim 1, wherein each of the first and second sound absorbing materials is non-woven or cork.

6. The ultrasonic sensor as set forth in claim 1, wherein the first sound absorbing material is formed in a form in which it is filled in a space between a side of the piezoelectric element and a wall surface of the case.

7. The ultrasonic sensor as set forth in claim 1, wherein the case is made of aluminum.

8. The ultrasonic sensor as set forth in claim 1, wherein when the piezoelectric element is mounted in the case, the piezoelectric element is adhered to the case by an adhesive.

9. The ultrasonic sensor as set forth in claim 8, wherein the adhesive is epoxy.

10. The ultrasonic sensor as set forth in claim 1, wherein when a bottom surface of the case has an oval shape, an area of the first sound absorbing material except for the through-hole in which the piezoelectric element is to be mounted is formed so as to correspond to the oval shape, and the second sound absorbing material is formed so as to correspond to the oval shape.
